(19) United States
(12) Patent Application Publication
(10) Pub. No.: US 2014/0108589 A1
(43) Pub. Date: Apr. 17, 2014

(54) TESTING AN EXECUTABLE BINARY FILE USING AN INJECTION PROXY

(71) Applicant: Sanjeev Dhanda, San Francisco, CA (US)

(72) Inventor: Sanjeev Dhanda, San Francisco, CA (US)

(21) Appl. No.: 13/649,295

(22) Filed: Oct. 11, 2012

(51) Int. Cl. G06F 15/16

(52) U.S. Cl. 709/217

(57) ABSTRACT

Methods, systems, and apparatus for testing a binary are described. A method includes receiving a request from a binary under test, transmitting the request to a live backend system, receiving a response to the transmitted request from the live backend system where the received response including a plurality of fields, modifying the received response by selectively altering a specified subset of the plurality of fields in the received response according to predetermined testing requirements and leaving the remaining fields in the received response unaltered, and transmitting the modified response to the binary under test.

### BACKGROUND

This specification relates to testing executable binary files.

Binary files (“binaries”) are machine-executable files that have been compiled from source code written by a developer. Developers can test their binaries by running the binaries through test scenarios. Typically, a mock object is used to simulate a real object that, during actual, live run time, would be accessed by a binary. A mock object is a simulated object that mimics the behavior of the real object. But a mock object, the creation of which generally involves substantial effort, typically is specific to particulars of the binary in its current state. If the binary is subsequently modified, the mock object also ideally should be modified to test the modified binary. And if the binary under test is being changed rapidly, the mock object also may have to be updated rapidly to ensure that the simulation is up-to-date and not stale.

### SUMMARY

This specification describes technologies relating to testing an executable binary file using an injection proxy to simulate real world situations. The injection proxy sits between the binary under test and a real object, such as a live backend system. The injection proxy modifies a response from the backend system by altering a specified set of fields. The other fields of the response remain unchanged and are thus based on the current status of the live backend system. The injection proxy returns the modified response to the binary under test.

In general, an innovative aspect of the subject matter described in this specification can be implemented in methods for testing a binary using an injection proxy. Methods for testing a binary may include receiving a request from a binary under test, transmitting the request to a live backend system, receiving a response to the transmitted request from the live backend system where the response includes a plurality of fields, modifying the received response by selectively altering a specified subset of the plurality of fields in the received response according to predetermined testing requirements and leaving the remaining fields in the received response unaltered, and transmitting the modified response to the binary under test. Other potential implementations include corresponding system, apparatus, and/or computer programs configured to perform the actions of the methods, encoded on computer storage devices.

These and other implementations can optionally include one or more of the following features. The method may further include generating a hash value based on the request and storing the modified response based on the hash value. The method may further include receiving a second request from the binary under test, generating a hash value based on the second request, determining that the hash value is associated with a stored response, and transmitting the stored response to the binary under test. The request may be a request for an advertisement. The response may be an advertisement. The binary under test may be a binary that renders the advertisement. The live backend system may be an advertisement server. The advertisement may include visible fields. Modifying the response may include modifying the visible fields of the advertisement. The visible fields of the advertisement may include one or more of a title of the advertisement, text in the advertisement, or a hyperlink in the advertisement. The method may further include receiving input identifying the specified subset of fields in the received response to be altered. The method may further include receiving input that controls how the specified subset of fields is to be altered.

Particular implementations of the subject matter described in this specification may be implemented to realize one or more of the following potential advantages. To simulate real world situations, an injection proxy may be used instead of a mock object. Testing a binary using the injection proxy, as opposed to the mock object, helps to ensure that, for the unchanged fields, the response received by the binary reflects up-to-date responses from real objects accessed via the live backend. At the same time, the injection proxy can control the specified set of fields and set the returned responses to any values that make sense for the current binary being tested. The injection proxy is programmable via an application programming interface (API) that enables the testing team to change which of the fields in the injection proxy are passed through from the live backend unchanged and which specified set of fields are to be altered to perform the desired testing.

Details of one or more implementations of the subject matter described in this specification are set forth in the accompanying drawings and description below. Other features, aspects, and potential advantages of the subject matter will become apparent from the description, the drawings, and the claims.

### BRIEF DESCRIPTION OF THE DRAWINGS

FIG. 1 is a block diagram of an example system for testing a binary using an injection proxy.

FIG. 2 is a block diagram of example units in an injection proxy for processing requests from a binary and responses from a live backend system.

FIG. 3 is a flowchart of an example process for testing a binary using an injection proxy.

FIG. 4 is a block diagram of a programmable processing system.

### DETAILED DESCRIPTION

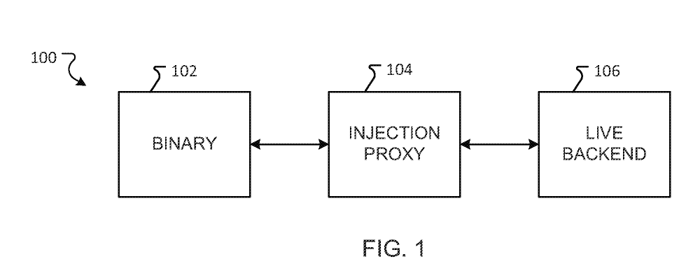

FIG. 1 is a block diagram of an example system 100 for testing a binary 102 using an injection proxy 104. The binary 102 may be a machine-executable file compiled from source code written by a developer. For example, the binary 102 may include instructions that are executed by a processing device of a computer system to render content, such as a file, a web page, or an advertisement, for display on a display screen of the computer system.

The live backend system 106 provides resources to the binary 102. Examples of a live backend system 106 include a web server, an advertisement server, or a search engine. Examples of resources include a file, a web page, or an advertisement. For example, a web server may provide web pages to the binary 102. An advertisement server may provide advertisements to the binary 102. A search engine may provide a search results in a search results page to the binary 102.

The injection proxy 104 sits between the binary 102 and the live backend system 106. The injection proxy 104 acts as an intermediary between the binary 102 and the live backend system 106. The binary 102 connects to the injection proxy 104 when requesting a resource from the live backend system 106. The injection proxy 104 provides the resource to the binary 102 by connecting to the backend system 106 and requesting the resource from the backend system 106 on behalf of the binary 102. When the injection proxy 104 receives a response from the backend system 106, the injection proxy 104 modifies the response by altering a specified set of fields of the resource, e.g., visible fields of an advertisement, that is desired for testing of the binary 102. The injection proxy 104 returns the modified response to the binary 102. The injection proxy 104 may store the response received from the backend system 106 or the modified response in a cache. If the injection proxy 104 subsequently receives a request for the same resource from the binary 102, the injection proxy 104 may return a response to the binary 102 from the cache without requesting the resource from the backend system 106.

The injection proxy is programmable via an application programming interface (API) that enables a user to change which of the fields in a response are passed through from the live backend unchanged and which specified set of fields are to be altered to perform the desired testing. In some implementations, the injection proxy 104 may be an application running on the same computer system as the binary 102. In some implementations, the injection proxy 104 may be implemented on a computer system or a server separate from the computer system that is executing the binary 102. In some implementations, the binary 102, the injection proxy 104, and the live backend system 106 may be connected through a network (not shown), such as a local area network (LAN), wide area network (WAN), the Internet, or a combination thereof.

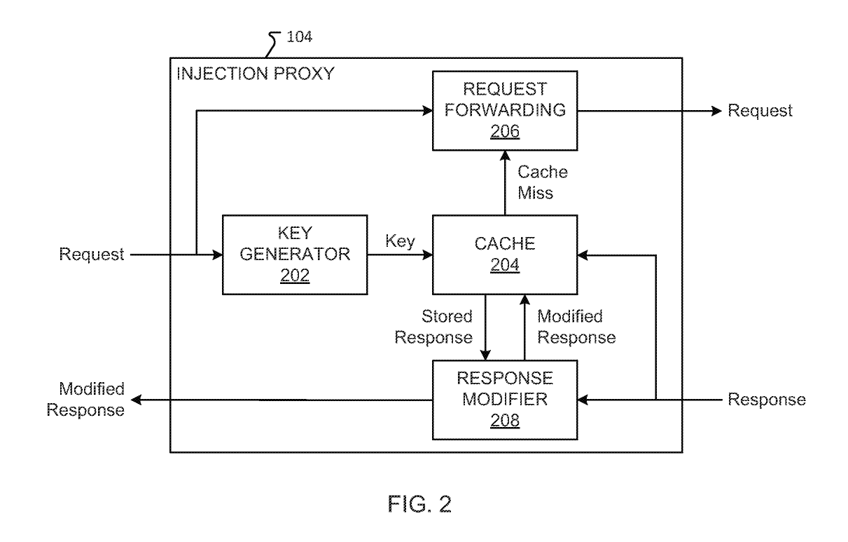

FIG. 2 is a block diagram of example components in the injection proxy 104 for processing requests from the binary 102 and responses from the backend system 106. The components in the injection proxy 104 may include a key generator 202, a cache 204, a request forwarding unit 206, and a response modifier 208.

The key generator 202 receives a request from the binary 102 and generates a key based on the request. The key generator 202 may be, for example, a hash function that generates a hash value based on the request. The hash function may map the request to an index corresponding to an entry of the cache 204 where a response to the request is or will be stored. The key is used to determine whether a response to the request is stored in the cache 204 and in which entry of the cache 204 to store a response received from the backend system 106.

If a response corresponding to the request is stored in the cache 204, the cache 204 returns the stored response. The cache 204 returns the response stored in the cache entry that corresponds to the key generated by the key generator 202 based on the request. The response returned by the cache 204 may be a response as originally received from the backend system 106, a modified version of the response received from the backend system 106, or both the original response and the modified response. The returned response may be modified by the response modifier 208 prior to transmitting the response to the binary 102.

If a response corresponding to the request is not stored in the cache 204, the injection proxy 104 forwards the request from the binary 102 to the backend system 106. The cache 204 may transmit a signal, such as a cache miss signal, to the request forwarding unit 206 indicating that the response is not stored in the cache. In response to the signal from the cache 204, the request forwarding unit 206 forwards the request from the binary 102 to the backend system 106.

The cache 204 stores the response after the response is received from the backend system 106. The cache 204 may store a response as originally received from the backend system 106, a modified version of the response received from the backend system 106, or both the original response and the modified response. The cache 204 stores the response in a cache entry that corresponds to the key generated by the key generator 202 based on the request associated with the response.

When a response is received from the backend system 106, the response modifier 208 may modify the response prior to storing the response in the cache 204 or transmitting the response to the binary 102. For example, the response modifier 208 may modify the response by altering a specified subset of fields of the resource included in the response that is desired for testing of the binary 102. The response modifier 208 may modify the specified subset of fields in the resource based on input received from a user identifying the specified subset of fields that is to be altered. The response modifier 208 may modify the specified subset of fields in the resource based on input received from a user that controls how the specified subset of fields is to be altered.

For example, the injection proxy 104 receives a response from a backend system 106, such as an advertisement server, that includes a resource, such as an advertisement. The advertisement includes visible fields, such as a title text field, a body text field, or a hyperlink text field, that are displayed to a user. The advertisement also includes invisible fields, such as formatting fields and font fields, that are not displayed to a user. The response modifier 208 may be configured by a user to modify one or more of the visible fields of the advertisement while leaving the remaining fields, including the invisible fields, of the advertisement unaltered.

For example, a user may want to test whether the binary 102 correctly renders Unicode characters in the visible fields of an advertisement. The user can configure the response modifier 208 to insert a Unicode character in one or more of the visible fields of the advertisement returned by the backend system 106. As another example, a user may want to test whether the binary 102 correctly renders an advertisement that includes the maximum number of characters allowed in the body of the advertisement. The user can configure the response modifier 208 to modify the body of the advertisement returned by the backend system 106 to include the maximum number of characters allowed.

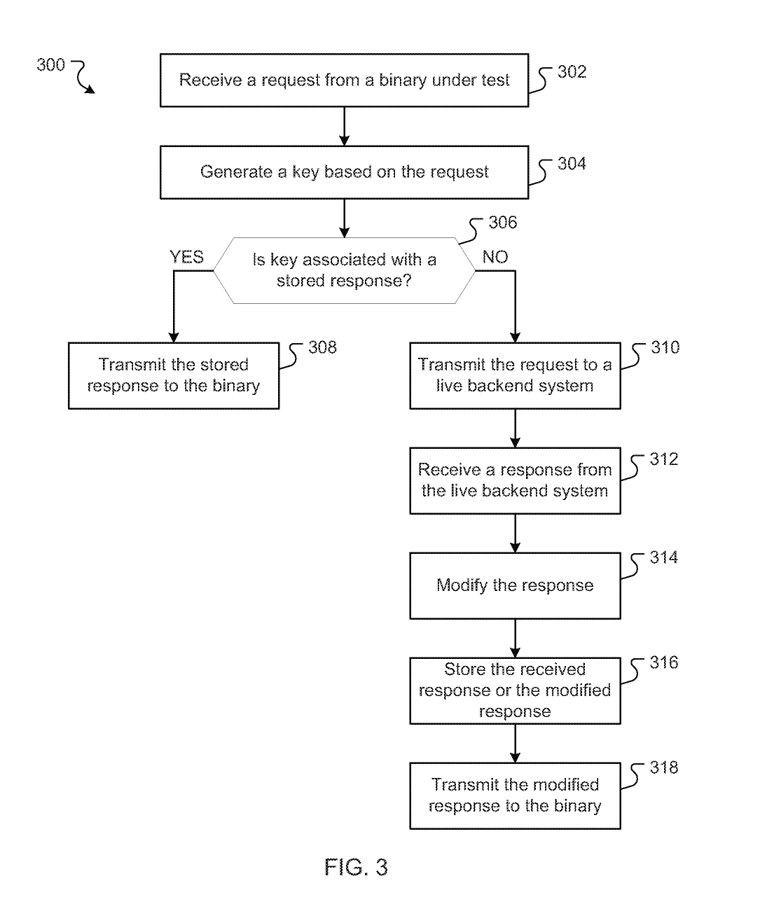

FIG. 3 is a flowchart of an example process 300 for testing a binary using an injection proxy. Briefly, the process 300 includes receiving a request from a binary under test, generating a key based on the request, and transmitting a response to the binary based on whether the key is associated with a stored response.

In further detail, the process 300 begins with the injection proxy receiving a request from a binary under test (302). The request may be a data structure that is transmitted from the binary to the injection proxy using a remote procedure call (RPC). The request may be a request for a resource, such as an advertisement, from a live backend system, such as an advertisement server.

The injection proxy generates a key based on the request (304). The injection proxy may include a hash function that generates the key, such as a hash value, based on the request.

The injection proxy determines whether the key is associated with a response stored in the injection proxy (306). The injection proxy may access a cache and determine whether a cache entry corresponding to the key is storing a valid response to the request.

If the key is associated with a stored response, the injection proxy transmits the stored response to the binary (308). The injection proxy may transmit the stored response without modification or modify the stored response before transmitting the modified response to the binary.

If the key is not associated with a stored response, the injection proxy transmits the request to the live backend system (310). When the injection proxy receives a response from the backend system (312), the injection proxy modifies the response (314). The received response may be a data structure that includes multiple fields. The injection proxy may modify the received response by selectively altering a specified subset of fields in the received response, such as the visible fields of an advertisement included in the received response, according to predetermined testing requirements. The remaining fields, such as the invisible fields of the advertisement, in the received response remain unchanged and are thus based on the current status of the live backend system.

The injection proxy stores the received response or the modified response (316). The injection proxy may store the received response or the modified response in a cache entry corresponding to the key generated based on the request. The injection proxy may simultaneously or subsequently transmit the modified response to the binary (318).

Implementations of the subject matter and the operations described in this specification can be configured in digital electronic circuitry, or in computer software, firmware, or hardware, including the structures disclosed in this specification and their structural equivalents, or in combinations of one or more of them. Implementations of the subject matter described in this specification can be configured as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be configured on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be configured in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

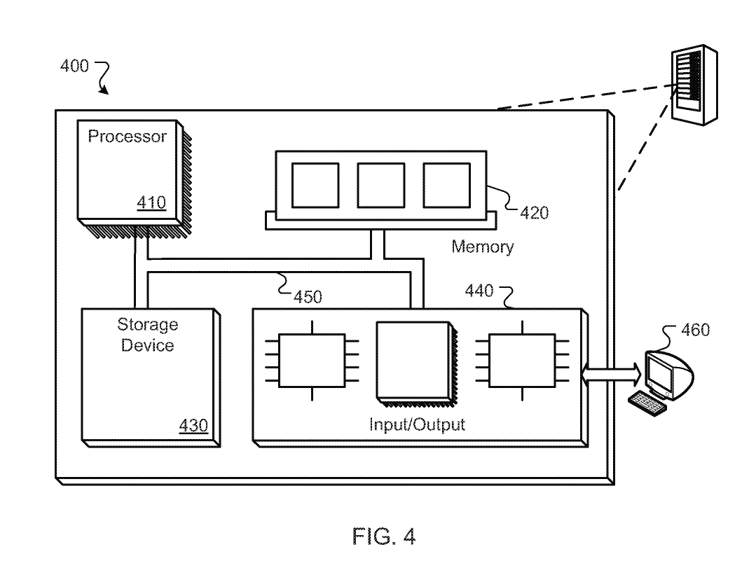

An example of one such type of computer is shown in FIG. 4, which shows a block diagram of a programmable processing system (system). The system 400 that can be utilized to implement the systems and methods described herein. The architecture of the system 400 can, for example, be used to implement a computer client, a computer server, or some other computer device.

The system 400 includes a processor 410, a memory 420, a storage device 430, and an input/output device 440. Each of the components 410, 420, 430, and 440 can, for example, be interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can, for example, include a hard disk device, an optical disk device, or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 460.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be configured in combination in a single implementation. Conversely, various features that are described in the context of a single implementation can also be configured in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a data processing apparatus, the method comprising:
receiving a request from a binary under test;
transmitting the request to a live backend system;
receiving a response to the transmitted request from the live backend system, the received response including a plurality of fields;
modifying the received response by selectively altering a specified subset of the plurality of fields in the received response according to predetermined testing requirements and leaving the remaining fields in the received response unaltered; and
transmitting the modified response to the binary under test.

2. The method of claim 1, further comprising:
generating a key based on the request; and
storing the modified response based on the key.

3. The method of claim 2, further comprising:
receiving a second request from the binary under test;
generating a key based on the second request;
determining that the key is associated with a stored response; and
transmitting the stored response to the binary under test.

4. The method of claim 1, wherein the request comprises a request for an advertisement, the response comprises an advertisement, the binary under test comprises a binary that renders the advertisement, and the live backend system comprises an advertisement server.

5. The method of claim 4, wherein the advertisement includes visible fields and invisible fields, and modifying the response comprises:
modifying visible fields of the advertisement.

6. The method of claim 5, wherein the visible fields of the advertisement include one or more of a title of the advertisement, text in the advertisement, or a hyperlink in the advertisement.

7. The method of claim 1, further comprising:
receiving input identifying the specified subset of fields in the received response to be altered.

8. The method of claim 1, further comprising:
receiving input that controls how the specified subset of fields is to be altered.

9. A computer storage medium encoded with instructions that when executed by a data processing device cause the data processing device to perform operations comprising:
receiving a request from a binary under test;
transmitting the request to a live backend system;
receiving a response to the transmitted request from the live backend system, the received response including a plurality of fields;
modifying the received response by selectively altering a specified subset of the plurality of fields in the received response according to predetermined testing requirements and leaving the remaining fields in the received response unaltered; and
transmitting the modified response to the binary under test.

10. The computer storage medium of claim 9, wherein the instructions that when executed by the data processing device cause the data processing device to perform operations further comprising:
generating a key based on the request; and
storing the modified response based on the key.

11. The computer storage medium of claim 10, wherein the instructions that when executed by the data processing device cause the data processing device to perform operations further comprising:
receiving a second request from the binary under test;
generating a key based on the second request;
determining that the key is associated with a stored response; and
transmitting the stored response to the binary under test.

12. The computer storage medium of claim 9, wherein the request comprises a request for an advertisement, the response comprises an advertisement, the binary under test comprises a binary that renders the advertisement, and the live backend system comprises an advertisement server.

13. The computer storage medium of claim 12, wherein the advertisement includes visible fields and invisible fields, and modifying the response comprises:
modifying visible fields of the advertisement.

14. The computer storage medium of claim 13, wherein the visible fields of the advertisement include one or more of a title of the advertisement, text in the advertisement, or a hyperlink in the advertisement.

15. The computer storage medium of claim 9, wherein the instructions that when executed by the data processing device cause the data processing device to perform operations further comprising:
receiving input identifying the specified subset of fields in the received response to be altered.

16. The computer storage medium of claim 9, wherein the instructions that when executed by the data processing device cause the data processing device to perform operations further comprising:
receiving input that controls how the specified subset of fields is to be altered.

17. A system, comprising:
a data processing apparatus; and
a non-transitory computer storage medium encoded with instructions that when executed by the data processing apparatus cause the data processing apparatus to perform operations comprising:
receiving a request from a binary under test;
transmitting the request to a live backend system;
receiving a response to the transmitted request from the live backend system, the received response including a plurality of fields;
modifying the received response by selectively altering a specified subset of the plurality of fields in the received response according to predetermined testing requirements and leaving the remaining fields in the received response unaltered; and
transmitting the modified response to the binary under test.

18. The system of claim 17, wherein the instructions that when executed by the data processing device cause the data processing device to perform operations further comprising:
generating a key based on the request; and
storing the modified response based on the key.

19. The system of claim 18, wherein the instructions that when executed by the data processing device cause the data processing device to perform operations further comprising:
receiving a second request from the binary under test;
generating a key based on the second request;
determining that the key is associated with a stored response; and
transmitting the stored response to the binary under test.

20. The system of claim 17, wherein the request comprises a request for an advertisement, the response comprises an advertisement, the binary under test comprises a binary that renders the advertisement, and the live backend system comprises an advertisement server.

21. The system of claim 20, wherein the advertisement includes visible fields and invisible fields, and modifying the response comprises:
modifying visible fields of the advertisement.

22. The system of claim 21, wherein the visible fields of the advertisement include one or more of a title of the advertisement, text in the advertisement, or a hyperlink in the advertisement.

23. The system of claim 17, wherein the instructions that when executed by the data processing device cause the data processing device to perform operations further comprising:
receiving input identifying the specified subset of fields in the received response to be altered.

24. The system of claim 17, wherein the instructions that when executed by the data processing device cause the data processing device to perform operations further comprising:
receiving input that controls how the specified subset of fields is to be altered.
